(19) United States
(12) Patent Application Publication
(10) Pub. No.: US 2026/0214366 A1
(43) Pub. Date: Jul. 23, 2026

(54) MICROPHONE DEVICE AND WINDSCREEN

(71) Applicant: Audio-Technica Corporation, Tokyo (JP)

(72) Inventor: Yoshiaki ABE, Tokyo (JP)

(21) Appl. No.: 19/572,443

(22) Filed: Mar. 19, 2026

Related U.S. Application Data
(63) Continuation of application No. PCT/JP2024/030297, filed on Aug. 26, 2024.

(30) Foreign Application Priority Data
Sep. 27, 2023 (JP) 2023-165278

(51) Int. Cl. H04R 1/08

(52) U.S. Cl. CPC H04R 1/086

(57) ABSTRACT

A microphone device includes: a microphone main body having a sound collecting part; a windscreen having a windscreen member that covers the sound collecting part, wherein the windscreen member includes: a receiving portion extending inward into the windscreen member from an opening through which the microphone main body is inserted; and a through hole penetrating the windscreen member in a direction intersecting an extending direction of the receiving portion and connected to the receiving portion, at a position different from the opening; and a retaining member connected to the microphone main body through the through hole.

### CROSS-REFERENCE TO RELATED APPLICATIONS

The present application is a continuation application of International Application number PCT/JP2024/030297, filed on Aug. 26, 2024, which claims priority to Japanese Application 2023-165278 filed Sep. 27, 2023 and the contents of both are incorporated herein by reference in their entirety.

### BACKGROUND OF THE INVENTION

The present invention relates to a microphone device and a windscreen.

Conventionally, a microphone device in which a windscreen is attached to a microphone main body has been known (for example, see Japanese Unexamined Patent Application Publication No 2022-10840).

However, in the conventional configuration, there has been a problem in that the windscreen is prone to come off from the microphone main body.

### BRIEF SUMMARY OF THE INVENTION

The present invention focuses on this point, and its object is to provide a microphone device and a windscreen capable of preventing detachment of the windscreen.

One aspect of the present disclosure provides a microphone device including: a microphone main body having a sound collecting part; a windscreen having a windscreen member that covers the sound collecting part, wherein the windscreen member includes: a receiving portion extending inward into the windscreen member from an opening through which the microphone main body is inserted; and a through hole penetrating the windscreen member in a direction intersecting an extending direction of the receiving portion and connected to the receiving portion, at a position different from the opening; and a retaining member connected to the microphone main body through the through hole.

Another aspect of the present disclosure provides a windscreen including: a receiving portion formed in a windscreen member which is a porous elastic body or a windscreen member whose surface is covered with a fibrous member, the receiving portion having an opening through which a microphone main body is inserted and extending inward into the windscreen member from the opening; and a through hole penetrating the windscreen member in a direction intersecting an extending direction of the receiving portion and connected to the receiving portion, at a position different from the opening.

### BRIEF DESCRIPTION OF THE DRAWINGS

FIG. 1 is a perspective view showing a microphone device according to an embodiment of the present invention.

FIG. 2 is a schematic view showing a connection structure of a microphone main body, a windscreen, and a clip.

FIG. 3A is a view showing the windscreen.

FIG. 3B is a view showing the windscreen.

FIG. 4 is a side view of the clip.

FIG. 5 is a diagram showing a microphone device according to a modification.

### DETAILED DESCRIPTION OF THE INVENTION

Hereinafter, the present disclosure will be described through exemplary embodiments, but the following exemplary embodiments do not limit the invention according to the claims, and not all combinations of features described in the exemplary embodiments are necessarily essential to the invention.

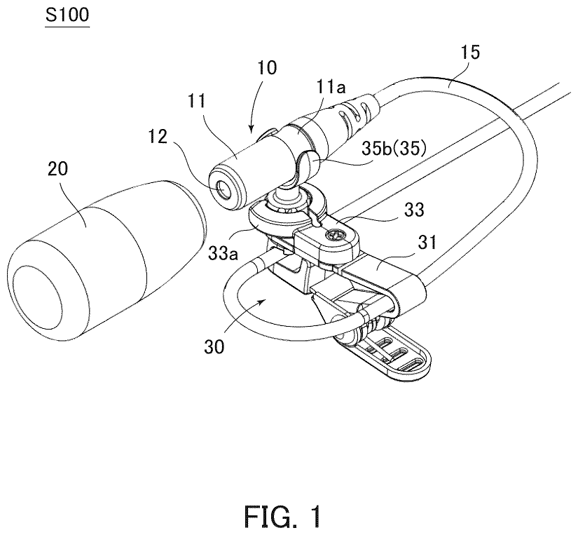

Hereinafter, embodiments of the present invention will be described. FIG. 1 is a perspective view showing a microphone device according to an embodiment of the present invention. As shown in FIG. 1, the microphone device S100 includes a microphone main body 10, a windscreen 20, and a clip 30. FIG. 1 shows, in order to facilitate understanding of the configuration of the microphone device S100, the microphone main body 10 attached to the clip 30 in a state in which the windscreen 20 is not attached.

The microphone main body 10 includes a housing 11 and a sound collecting part 12. The housing 11 has a cylindrical outer shape, and a cable 15 is connected to one end thereof. The sound collecting part 12 is provided at a distal end portion of the housing 11. An annular concave portion 11a is formed on an outer peripheral surface of the housing 11.

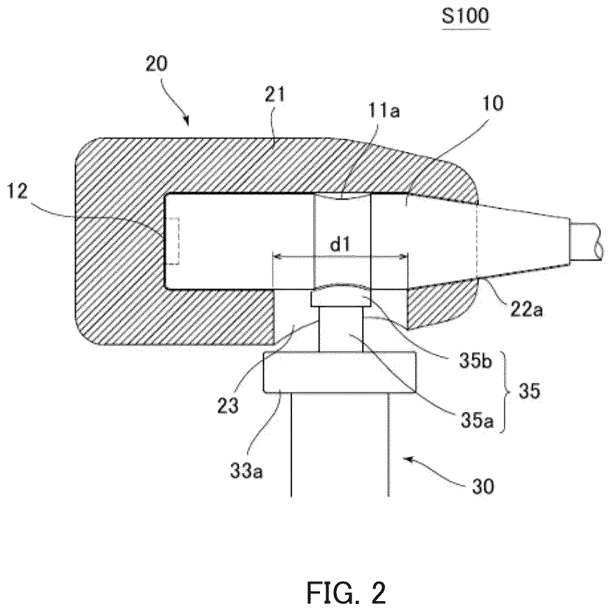

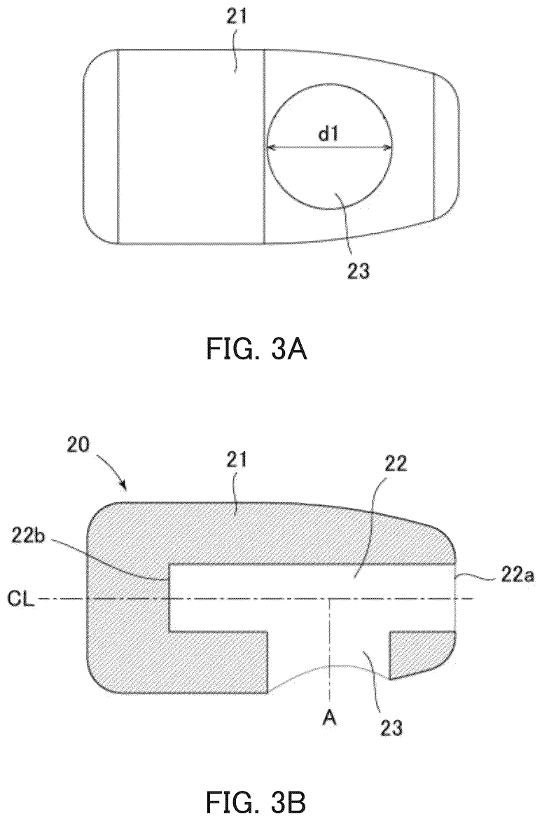

FIG. 2 is a schematic diagram showing a connection structure of the microphone main body 10, the windscreen 20, and the clip 30. FIGS. 3A and 3B are each a diagram illustrating the windscreen 20. FIG. 3A is a side view of the windscreen 20, and FIG. 3B is a cross-sectional view of the windscreen 20.

As shown in FIG. 2, the windscreen 20 is attached to the microphone main body 10 such that the windscreen 20 covers the sound collecting part 12. The windscreen 20 includes a windscreen member 21. The windscreen member 21 is, for example, a sponge-like porous elastic body. As shown in FIG. 3, the windscreen member 21 has a receiving portion 22 and a through hole 23.

In this example, the receiving portion 22 is a hole formed in a cylindrical shape along a center line CL in the longitudinal direction of the windscreen member 21 and extends inward from an outer surface of the windscreen member 21. The receiving portion 22 has an opening 22a, and the microphone main body 10 is inserted through the opening 22a. An end portion 22b of the receiving portion 22 opposite to the opening 22a is closed.

The through hole 23 is provided in a part of the peripheral wall of the windscreen member 21. The shape of the opening of the through hole 23 may be any shape, but in this example, the through hole 23 has a circular opening. Specifically, the through hole 23 is formed at a position different from the opening 22a to extend in a direction (the A-axis direction in FIG. 3) intersecting an extending direction of the receiving portion 22. The through hole 23 penetrates the peripheral wall of the windscreen member 21 and is connected to the receiving portion 22. As shown in FIG. 2, the through hole 23 is provided at a position closer to the opening 22a than a region of the windscreen member 21 covering the sound collecting part 12.

A diameter d1 of the opening of the through hole 23 is larger than an outer dimension d2 of a distal end portion 35b of the clip 30 described later. With such a configuration, it is possible to easily insert the distal end portion 35b into an interior of the windscreen member 21 through the through hole 23, and to easily attach the distal end portion 35b to the microphone main body 10.

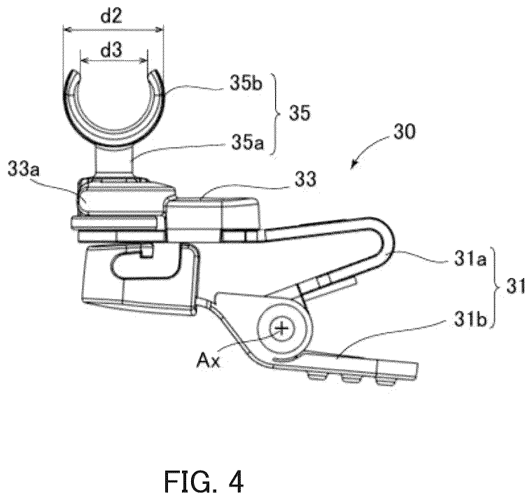

FIG. 4 is a side view of the clip 30. The clip 30 is for attaching the microphone main body 10 to an object such as clothes of a user. As shown in FIGS. 1 and 4, the clip 30 includes a clip main body 31, a connecting member 33, and a retaining member 35.

Specifically, the clip main body 31 includes a main body member 31a and a movable member 31b. The main body member 31a is, for example, a metal plate-shaped member and has a bent shape. The movable member 31b is attached to the main body member 31a. The movable member 31b is rotatable about an axis Ax.

As shown in FIG. 1, the connecting member 33 is a member that supports the retaining member 35, and is fixed to the clip main body 31. Specifically, the connecting member 33 has a holding portion 33a that supports a part of the retaining member 35. As shown in FIG. 1, the holding portion 33a is made up of a pair of members formed in a substantially semicircular shape, and holds the retaining member 35 by sandwiching a part of the retaining member 35 between the pair of members.

In this example, the outer shape of the holding portion 33a is a disk shape. As illustrated in FIG. 2, the diameter of the holding portion 33a is larger than the diameter d1 of the through hole 23. With such a configuration, since the holding portion 33a is positioned to cover the through hole 23 in the assembled state as shown in FIG. 2, foreign matter or the like is unlikely to enter the through hole 23. It should be noted that the holding portion 33a may be in contact with the windscreen member 21 or may be spaced apart therefrom, but in this example, the holding portion 33a is spaced apart from the windscreen member 21.

The retaining member 35 has a supporting portion 35a and the distal end portion 35b. The supporting portion 35a is a columnar member that supports the distal end portion 35b and extends in a direction away from the distal end portion 35b.

The distal end portion 35b is a portion connected to the microphone main body 10, and has a C-shape as shown in FIG. 4. A dimension d3 of the C-shaped opening portion of the distal end portion 35b is formed to be smaller than the diameter of the concave portion 11a. The distal end portion 35b is provided to elastically fit into the annular concave portion 11a of the microphone main body 10 by pressing the retaining member 35 toward the microphone main body 10. The distal end portion 35b is provided so that the distal end portion 35b is disengaged from the concave portion 11a by pulling the retaining member 35 in a direction away from the microphone main body 10.

In the present invention, a configuration may be adopted in which the concave portion 11a is not provided in the microphone main body 10 and the distal end portion 35b is fitted to the outer peripheral surface of the cylindrical housing 11, but in a configuration such as shown in FIG. 1, the following advantages are obtained. Specifically, in the configuration in which the distal end portion 35b is fitted to the outer peripheral surface of the cylindrical housing 11, the outer shape of the distal end portion 35b becomes large, which may require the shape of an inner hole of the windscreen 20 to correspond to the outer shape of the distal end portion 35b. However, with the configuration in which the distal end portion 35b is fitted into the concave portion 11a as shown in FIG. 1, the distal end portion 35b does not significantly protrude outward in the radial direction of the housing 11, and therefore even if an inner hole of the windscreen 20 has a straight columnar shape, the windscreen 20 can satisfactorily cover the microphone main body 10 and the distal end portion 35b while following the outer shapes thereof.

As shown in FIG. 2, the retaining member 35 is attached to the microphone main body 10 on which the windscreen 20 is mounted. Specifically, the retaining member 35 is disposed to pass through the through hole 23 of the windscreen 20, and is connected to the microphone main body 10.

### Effect of the Microphone Device S100

As described above, in the microphone device S100 of the present embodiment, as shown in FIG. 2, the windscreen 20 is attached to the microphone main body 10, and the retaining member 35 of the clip 30 is attached so as to pass through the through hole 23 of the windscreen 20. In such a configuration, even if a force in a direction to detach the windscreen 20 from the microphone main body 10 is applied to the windscreen 20, since the retaining member 35 is provided in the through hole 23, detachment of the windscreen 20 can be prevented.

In order to prevent detachment of the windscreen 20, for example, it is conceivable to adopt a configuration in which a frame member having higher rigidity than the windscreen member 21 is provided inside the windscreen member 21 and is mechanically coupled to the microphone main body 10. Compared to such a configuration, the microphone device S100 of the present embodiment can prevent detachment of the windscreen 20 with a simpler configuration.

### Modification 1

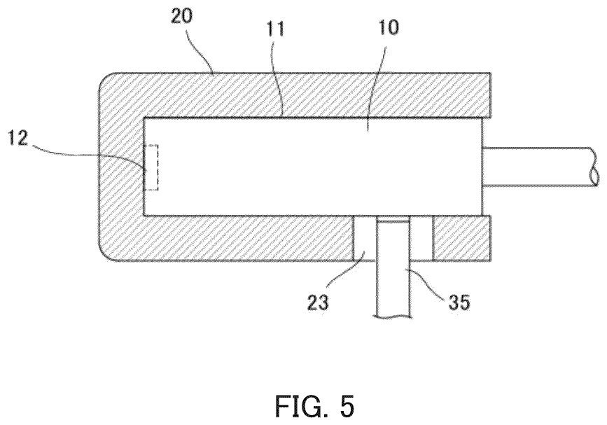

FIG. 5 is a diagram illustrating a microphone device according to a modification. The microphone device of FIG. 5 has a shape in which the windscreen 20 covers the entire microphone main body 10. Specifically, the housing 11 that accommodates the sound collecting part 12 is entirely covered by the windscreen 20. With such a configuration, since vibrations transmitted to the sound collecting part 12 through the housing 11 are reduced, the recording performance of the microphone device can be improved.

As illustrated in FIG. 5, the microphone main body 10 does not need to be provided with the concave portion 11a (see FIG. 2). Regarding the retaining member, for example, it may be a rod-shaped retaining member 35 having a connecting portion, such as a screw portion, at its distal end portion, which is connected to the microphone main body 10. Even with such a configuration, it is possible to prevent detachment of the windscreen 20.

In the above embodiment, the porous windscreen member is exemplified, but the windscreen member may be a member whose surface is covered with a fibrous member. The windscreen member is not necessarily a single member, and may be composed of a plurality of members made of different materials. The retaining member is not necessarily a part of the clip 30 and may be any member that is connected to the microphone main body 10 via the through hole 23.

The present disclosure is explained based on the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments. Further, effects of the new exemplary embodiments brought by the combinations also have the effects of the original exemplary embodiments.

What is claimed is:

1. A microphone device comprising:
a microphone main body having a sound collecting part;
a windscreen having a windscreen member that covers the sound collecting part, wherein the windscreen member includes:
a receiving portion extending inward into the windscreen member from an opening through which the microphone main body is inserted; and
a through hole penetrating the windscreen member in a direction intersecting an extending direction of the receiving portion and connected to the receiving portion, at a position different from the opening; and
a retaining member connected to the microphone main body through the through hole.

2. The microphone device according to claim 1, wherein the through hole is provided at a position closer to the opening than a region of the windscreen member covering the sound collecting part.

3. The microphone device according to claim 1, wherein the retaining member includes:
a distal end portion connected to the microphone main body; and
a supporting portion extending in a direction away from the distal end portion, and the distal end portion is removably connected to the microphone main body.

4. The microphone device according to claim 3, wherein the distal end portion has a C-shape that elastically fits into the microphone main body.

5. The microphone device according to claim 4, wherein the distal end portion is fitted into an annular concave portion formed in an outer peripheral surface of the microphone main body.

6. The microphone device according to claim 3, wherein the distal end portion and the supporting portion are provided in a part of a clip for attaching the microphone main body to an object.

7. The microphone device according to claim 1, wherein the windscreen has a shape covering the entire microphone main body.

8. A windscreen comprising:
a receiving portion formed in a windscreen member which is a porous elastic body or a windscreen member whose surface is covered with a fibrous member, the receiving portion having an opening through which a microphone main body is inserted and extending inward into the windscreen member from the opening; and
a through hole penetrating the windscreen member in a direction intersecting an extending direction of the receiving portion and connected to the receiving portion, at a position different from the opening.
